(19) United States
(12) Patent Application Publication
(10) Pub. No.: US 2009/0035037 A1
(43) Pub. Date: Feb. 5, 2009

(54) DOCTOR BLADE CHAMBER FOR HIGH VISCOUS INK

(76) Inventor: Allan R. Broch, Hvidovre (DK)

Correspondence Address: WINSTON & STRAWN LLP;PATENT DEPARTMENT, 1700 K STREET, N.W., WASHINGTON, DC, 20006, US

(21) Appl. No.: 12/282,069

(22) PCT Filed: Mar. 9, 2007
(86) PCT No.: PCT/IB07/50795

§ 371 Date: Sep. 8, 2008

(30) Foreign Application Priority Data
Mar. 9, 2006 (DK) PA 2006 00340

(51) Int. Cl. G03G 21/00

(52) U.S. Cl. 399/350

(57) ABSTRACT

A doctor blade chamber for transferring high viscous ink to at least one anilox roller. The doctor blade chamber has two doctor blades, at least one partitioning wall and a hollow casing which together with the anilox roller define an ink chamber. Each of the doctor blades has an edge positioned against the anilox roller. The doctor blade chamber requires a minimum of skilled personnel for maintaining and adjusting the unit during operation and when changing the anilox roller. The doctor blade chamber is independent of the rotation velocity of the anilox roller and during operation the ink is transferred to the anilox roller without applying pressure in the ink chamber.

The present invention relates to a doctor blade chamber for transferring high viscous ink to at least one anilox roller, wherein the doctor blade chamber comprises at least two doctor blades, at least one partitioning wall and a hollow casing that together with an anilox roller defines an ink chamber.

Doctor blade chambers are commercially used for various printing processes e.g. flexographic or planographic printing. These printing processes can be both direct printing and offset printing processes and are generally used for printing tasks where a high production speed is desired.

Inks used for doctor blade chambers in combination with screen rollers or anilox rollers are normally low viscous liquid inks, utilizing solvent or water as liquefier. The screen roller or anilox roller has a number of small cavities conveying the ink from the ink chamber to the successive rollers. In order effectively to fill these cavities the ink has to have a viscous typically lower than 500 mPa·s.

Low viscous water-based ink is mainly used on kraft, corrugated, lightweight news-type paper or polyethylene film, while solvent-based inks are used on films and some paper surfaces.

The water-based inks are generally slower to penetrate the print material and have a longer drying time. The long drying time is desired in order to avoid build up of dried ink on the rollers of the printing system.

Solvent-based inks have a short drying time, which in general causes problems of build-up of ink on the rollers. Especially, when a printing system is stopped, either for maintenance, during breakdown or due to ordinary change of job, the ink will dry out on the rollers causing extensive need for cleaning. The short drying time of the solvent based inks is desired because it is possible quickly to move the printed material to a successive process. However, exposure to solvents used in these inks are associated with health hazards and are therefore generally avoided.

Considering both environmental problems using solvents and the drying time, the use of high viscous inks could be beneficial. High viscous ink of at least 200 Poise (equal to 20 Pa·s) has in general a low content of solvent and is furthermore preferred because of their generally higher content of pigment. When carrying out printing tasks where a high amount of pigment is needed, the risk of scumming is present using low viscous ink. Especially, when printing on relatively rough surfaces e.g. egg trays or non-absorbent materials the risk of scumming is high and therefore high viscous ink is preferred.

The high viscous inks e.g. UV flexography inks are also preferred because they are less likely to dry out on the rollers during still stand.

US Patent application No. 2005/0150405 discloses a dry offset printing system using a doctor blade chamber and an ink cartridge. The ink is pumped from the ink cartridge to the doctor blades chamber from where the ink is transferred to the screen roller, excessive ink is let back to the ink cartridge. The disadvantage of this inking unit is that it needs to use ink that could be pumped, meaning that the ink in its very nature must have a low viscosity, and that the inking unit is highly adapted to the specific rollers of the invention.

European Patent No. 0401 250 discloses an enclosed blade chamber inking mechanism with partitioning means. The partitioning means functions as partitioning walls for the enclosed doctor blade chamber employed for preventing ink to leak from the doctor blade chamber. These partitioning means are held in position by clamping force. This prior art inking mechanism is provided with openings or studs for leading the ink into and out of the enclosed blade chamber. In order to fill the inking mechanism with ink using the studs, the ink needs to be a low viscous fluid and not pasty high viscous ink.

The desire of minimizing the risk of scumming and still having a high production speed creates a need for a doctor blade chamber that is capable of conveying high viscous ink e.g. UV flexo ink to an anilox roller.

Such doctor blade chamber would facilitate a flexographic or planographic dry offset printing system where the high printing speed of these systems and the benefits of using the high viscous ink are combined.

The known doctor blade chambers are adapted to low viscous liquid inks and therefore not usable for high viscous pasty ink. These doctor blade chambers are arranged with a reservoir for refilling with ink from a larger ink container using pumps. Attending to these known doctor blade chambers is rather difficult and time-consuming for an often busy staff. Furthermore, if manually operated, the refilling of the reservoir easily results in ink running down the sides of the chamber. These sides must then laboriously be washed off so as not be left in an unacceptable greasy state.

A doctor blade is a mainly thin elongate metal strip, which cleans or scrapes excess ink from cavities of a printing roller e.g. screen roller or anilox roller, leaving ink only in the cavities.

Furthermore, when the doctor blade scrapes excessive ink of the printing roller, undesired heat is generated in the chamber due to the friction between the doctor blades and the roller in contact with the ink in the fountain. Thus, chambers having more than one doctor blade is avoided.

When filling the cavities of the anilox roller it is essential that existing air and/or other gasses is removed in order to ensure that the cavities in the anilox are completely field with ink.

In the known doctor blade chamber, this is achieved by subjecting the ink in the chamber to pressure whereby the ink is forced into contact with the anilox rollers. Such arrangement necessitates that the ink is pumpable, thus only low viscous liquefied ink can be used in the known doctor blade chambers.

A problem in this respect, is that in the conventional doctor blade chambers, air or generated gases cannot be removed, as said chamber is under pressure, resulting in that e.g. air blocks the ink from refilling the cavity. Trapped air in the doctor blade chamber causes poor print quality and requires frequent maintenance of the anilox.

Thus, it is a first aspect of the present invention to provide a doctor blade chamber that transfers a constant amount of ink to an anilox roller when using high viscous ink without air and/or gasses gets trapped in the doctor blade chamber.

It is a second aspect of the present invention to provide a doctor blade chamber that requires a minimum of skilled personnel for maintaining and adjusting the unit during operation.

It is a third aspect according to the present invention to provide a doctor blade chamber that requires no adjustments when changing anilox roller.

It is a fourth aspect according to the present invention to provide a doctor blade chamber that in general necessitates no means for cooling or heating to achieve a preferred viscosity of the ink.

It is a fifth aspect according to the present invention to provide a doctor blade chamber that is independent of the rotation velocity of the anilox roller.

It is a sixth aspect according to the present invention to provide a doctor blade chamber where the ink, during operation, is transferred to the anilox roller without applying pressure in the ink chamber.

The novel and unique whereby this is achieved according to the present invention is the fact that the doctor blade chamber is arranged to be in communication with the surroundings.

By using a doctor blade chamber comprising at least two doctor blades, and wherein said chamber is in free communication with the surroundings, it is possible to use high viscous pasty printing ink and at the same time preventing that e.g. air gets trapped in the cavities in the anilox thereby reducing the printing quality.

The surroundings are typically the atmosphere or common air in a production facility or a building, in which both machines and operators are located.

Traditionally, using a doctor blade chamber with two doctor blades, it is essential that the ink in the chamber is subjected to pressure forcing the ink in contact with the anilox roller. Such arrangement necessitates that the ink is pumpable and the doctor blade chamber is a part of a closed system. Open doctor blade chambers are commonly used with just one doctor blade and low viscous liquefied ink.

The doctor blade scrapes of excessive ink and because of the heat generated by the friction between the doctor blades and the roller in contact with the ink in the fountain, it is traditionally avoided to have more than one doctor blade.

Using an open doctor blade chamber is a major advantage for the operators of the printing machine. The handling of the ink is simplified and the cleaning of the machine is faster.

The open doctor blade chamber of the present invention results in, that the ink, due to its high viscosity is pressed towards the groove arising between the doctor blade and the anilox roller along the longitudinal axis of the anilox roller. This has the effect that the cavities of the anilox roller are sure to be fully filled with ink.

Furthermore, as the air and/or generated gases easily can be removed from the chamber during use the risk of having e.g. air block the cavities in the printing roller is removed.

Thus, the use of a doctor blade chamber which is arranged for being in direct communication with the surrounding, ensures a very high print quality and requires frequent maintenance of the anilox

The anilox roller is typically a ceramic or chrome plated steel roll which haven been engraved with cells that carry and transfer the ink.

Furthermore, because the doctor blade of the present invention is capable of handling ink with a level of pigment of more than 80% the pure volume of ink used is lowered because the pigment is dissolved in less liquid than hitherto necessary for doctor blade chambers. As a natural consequence, since it is the amount of pigment is one of the limiting factors for the overall printing speed and the overall quality of the final print the quality of the print is raised using an ink with a high level of pigment. When it is possible constantly to contain more pigment in the doctor blade chamber as well as the ink chamber it is possible to achieve high quality prints with high contrast at very high printing speeds.

In a preferred embodiment of the invention the ink chamber can comprise an ink inlet and an outlet for air ensuring that the ink chamber in communication with the doctor blade chamber is in free and constant communication with the surrounding atmosphere. The ink inlet and the air outlet could in one embodiment be the same opening in the casing, as this will ensure a simple and efficient design of the ink chamber.

The doctor blade chamber and the ink chamber requires no pressure in order to force the ink from the ink chamber to the anilox roller. Thus, the ink inlet and the air outlet have no need for means regulating the pressure or the airflow in and out of the ink chamber.

Advantageously, the anilox roller and the doctor blade chamber could constitute an integrated unit detachable from the printing machine. Having the anilox roller integrated with the doctor blade chamber makes it possible to detach the doctor blade and thereby the ink chamber filled with ink, without the risk of spilling the ink.

Because the doctor blade chamber of the present invention is capable of handling ink with no drying agent it is possible to leave the ink in the integrated unit and thereby in the doctor blade chamber for use several hours later. Since the form rollers are easy to clean compared to the anilox and the doctor blade chamber a change to a second integrated unit with e.g. an different ink colour is a fast and simple matter.

The forme rollers are often adapted to the specific machine and therefore the forme rollers are usually left on the printing machine when changing the integrated unit. However, within the scope of the present invention the forme rollers and e.g. their lifting mechanism could be a part of the integrated unit if more machines could benefit from interchanging integrated units.

In a preferred embodiment the rounded outline of the doctor blades could be convex, preferably in a form of a semicircle or a semi ellipsoid, as this design has proven especially advantageous during tests.

Other than convex outlines for the doctor blades have been tested and it was found that these gave undesired effects on the ink. Furthermore, the durability of the doctor blades was extended using the convex outline.

The doctor blades typically have a thickness of 0.1 mm. However, it is obvious for the person skilled in the art that the thickness of the doctor blades could be changed in relation to the specific embodiment of the invention. Preferably, the doctor blades could be made of metal, plastic or composites thereof whereby the doctor blade can be designed for a specific type of ink.

In the specific contact point between the anilox roller and the doctor blade one tangent to the outer perimeter of the anilox roller can be drawn. Due to a force applied on the doctor blades these are slightly bend. However, with interpolation of said bended part it is possible to draw a straight line defining the bended part of the doctor blade. The intersection of the tangent of the anilox roller and the interpolated line of the doctor blade define two angles. An acute angle is defined outside the doctor blade chamber and an obtuse angle inside the doctor blade chamber. The acute angle between the tangent to the anilox roller and the interpolated line of the doctor blades bended part is preferably between 25° and 75°.

The friction between the doctor blade and the anilox roller generates heat and thereby a rise in temperature of the ink contained in the ink chamber will occur. Such rise in temperature is normally an undesired feature because the viscosity of the ink will change accordingly, giving that the doctor blade chamber should be readjusted in relation to the said change in viscosity of the ink. By heating the ink the viscosity of the ink will drop, typically 6-12% per degree Celsius. However, in a preferred embodiment of the invention the doctor blade chamber is indifferent to said change in viscosity and thus indifferent to changes in temperature.

In a preferred embodiment of the invention the ink temperature, is obtained and withheld without any means for regulation. The friction between the anilox roller and the doctor blade is sufficient to generate a desired ink temperature. If the viscosity of the printing ink is between 20 Pa·s to 70 Pa·s the inventors have surprisingly found, that if the temperature of the ink is raised to higher temperatures than the temperature recommended by the manufacture, the prints produced by the doctor blade chamber according to the present invention, still have a significantly good quality.

As an example can be mentioned, that if the preferred temperature stated by the producer, e.g. SUN Chemicals, is between 25° C.-35° C., extremely good printing qualities can still be obtained even if the temperature is raised to 50° C. or even to as high as 65° C., using the doctor blade chamber according to the present invention.

Thus, in order to obtain a desired temperature of the ink, the doctor blade chamber advantageously comprises means for regulating the temperature in the ink chamber. E.g. ink chambers containing a large amount of ink could be equipped with means for electrical heating.

Advantageously, the process of using the ink chamber comprises transferring ink to the anilox roller while simultaneously rotating the anilox roller and leading air from the anilox roller. This process gives the advantage that the anilox roller is always filled with ink whereby the printing process of transferring the ink to the material always has the necessary ink available. The process of leading air from the anilox roller ensures that no air is entrapped and therefore all cavities of the anilox roller easily fill with ink.

The anilox roller could e.g. have a capacity of 2-6.5 cm³ per square meter preferably 3-5.5 cm³ per square meter or most preferred 4-4.5 per square meter. In the resent years anilox rollers are commonly coated with various types of surface treatments. Such coatings are used for obtaining a specific property of the roller with respect to the ability to fill and empty the cavities of the anilox roller. With respect the present invention, tests have successfully been carried out using an anilox roller with 120 cavities per line, 60° incline and an easy-slip coating, of e.g. teflon.

Furthermore, as high viscous ink is used to refill the doctor blade chamber, it is advantageously that the chamber can be refilled quickly and easily without risk of spilled ink running down the sides of the chamber, which then would have to be cleaned after each filling. This ensures a minimum of ink-polluted wastewater and a minimum use of solvents.

In a preferred embodiment the printing ink has a viscosity not less than 10 Pa·s and preferably at least 20 Pa·s. This viscosity has the advantage that it is easy to handle for the operator and that the level of pigment contained in the ink can be more than 80%. Furthermore, the risk of ink drying on the rollers during a standstill is reduced thereby lowering the need for cleaning. This saves costly cleaning time and reduces the environmental impact from cleaning materials and ink polluted water. Since no drying agent is present in the ink in the preferred ink types the risk of ink drying in the anilox cups is minimized.

Advantageously, the rotation speed of the anilox roller can be at least 20 rpm, given, that the outer perimeter is approximately 0.5 meter. At this speed the ink is distributed to the full length of the anilox roller and the ink is firmly filling the cavities of the anilox roller. The doctor blade chamber is capable of inking anilox rollers having a rotation speed of up to 500 rpm. This is possible for anilox rollers oriented both horizontally and vertically. Furthermore, a doctor blade chamber according to the invention could easily be adapted to a screen roller with a longitudinal axis of 1500 mm.

Dry offset printing typically gives the opportunity of adding a thick layer of ink. The doctor blade chamber according to the invention can advantageously be used in such a dry offset printing process. Thereby is obtained a very simple and inexpensive process, which requires very low maintenance for the operator.

The print which are obtainable by the process according to the invention exhibit an extremely good printing quality having very sharp edges and the prints can therefore advantageously be used on material having rough or absorbing surfaces, e.g. paper, cardboard and/or egg tray.

The inventors have surprisingly found, that when the process according to the invention is used on e.g. egg trays the prints has a quality equal or better than the quality normally printed on paper with a smooth surface.

The invention will now be described by way of example only with reference to the drawing, in which

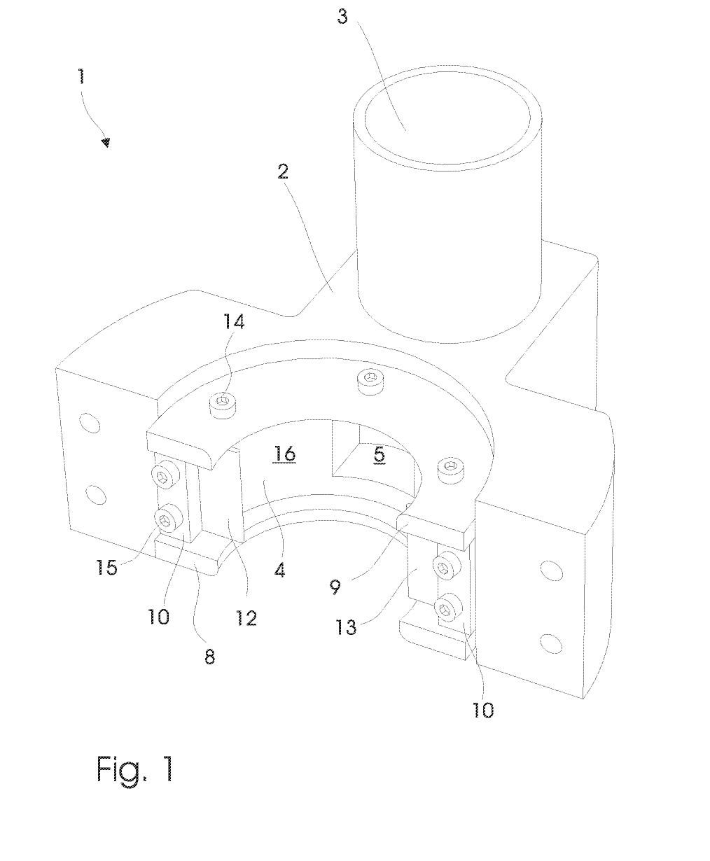

FIG. 1 shows, in perspective view the doctor blade chamber in an assembled state.

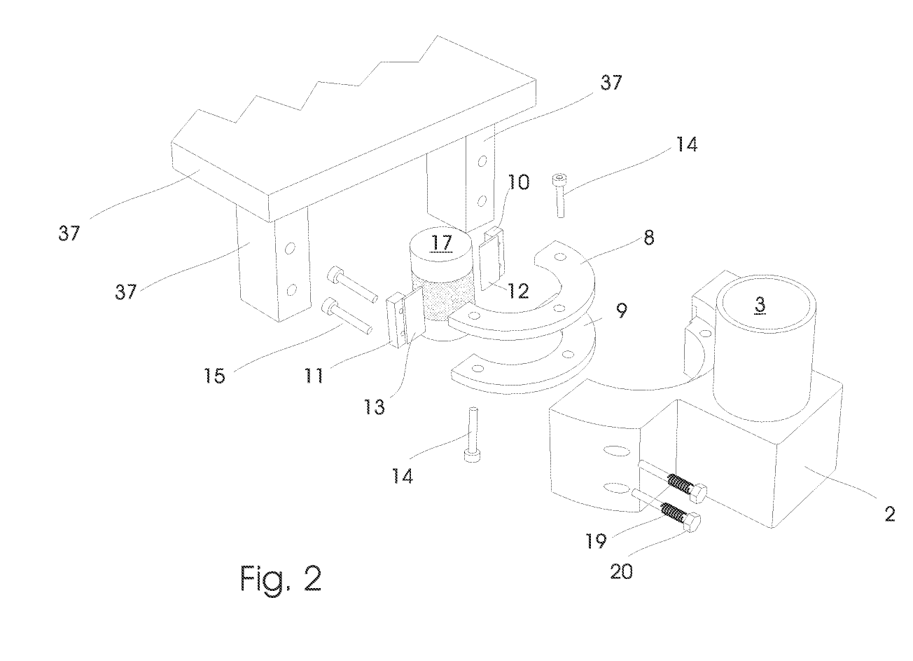

FIG. 2 shows, in exploded perspective view the doctor blade chamber of FIG. 1 according to the invention.

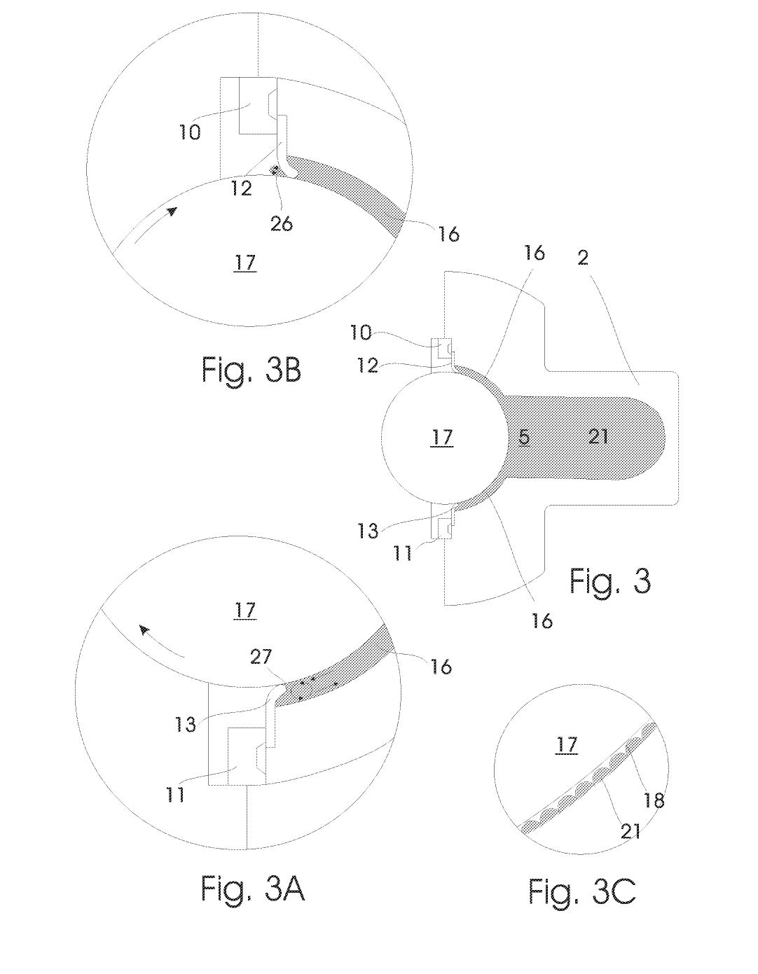

FIG. 3 shows, in a cross sectional view a hollow casing and the doctor blade chamber filled with ink. Furthermore, the figure shows the flow of ink in the chamber.

FIG. 3a-b shows, in an enlarged view of the doctor blades in contact with an anilox roller and the flow of ink in the vicinity of the doctor blades.

FIG. 3c shows, in an enlarged sectional view cavities of an anilox roller filled with ink.

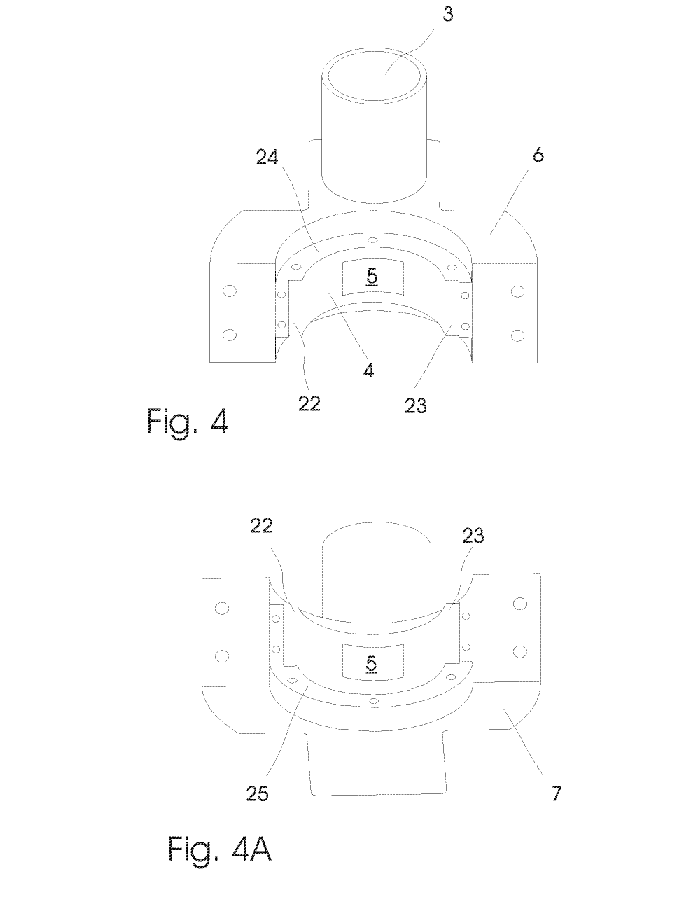

FIG. 4 shows, in a view perpendicular to FIG. 3 and slightly rotated a front view of a hollow casing.

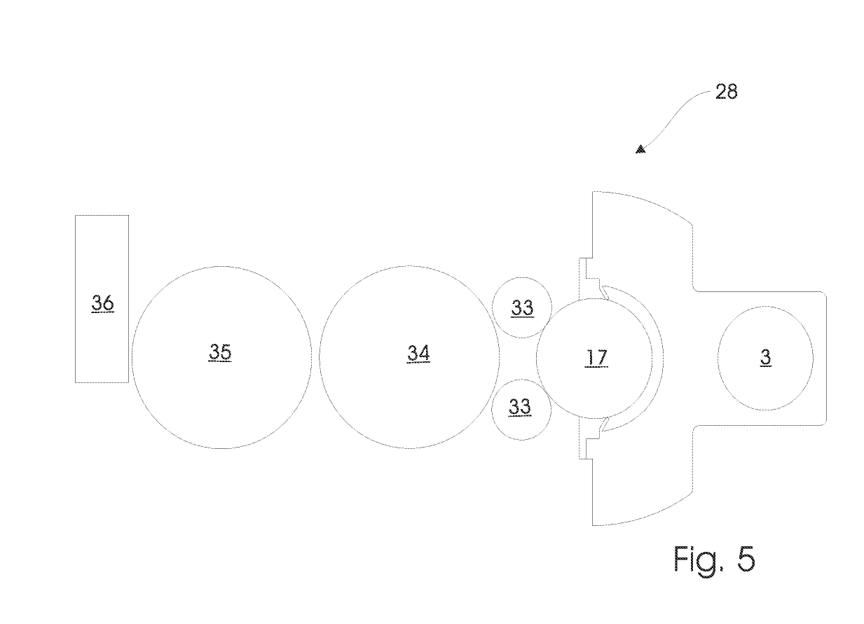

FIG. 5 schematically shows the doctor blade chamber according to the invention in relation to a dry offset printing system using a cliché system.

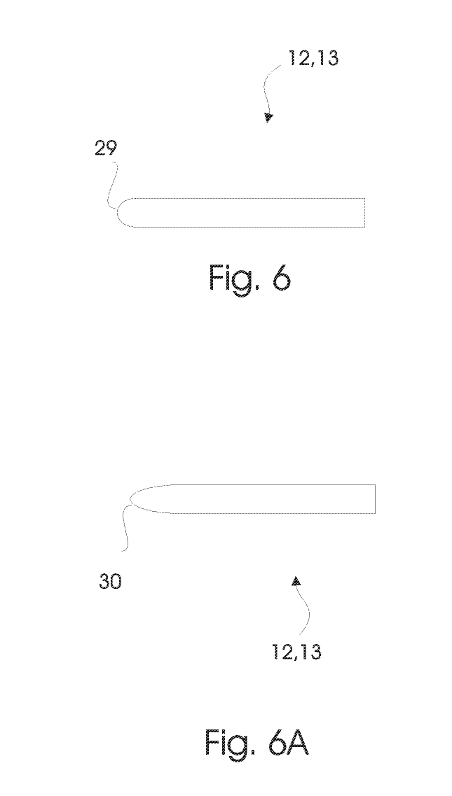

FIG. 6 and FIG. 6a shows, a cross sectional view of two embodiments of a doctor blade of the present invention having a convex outline.

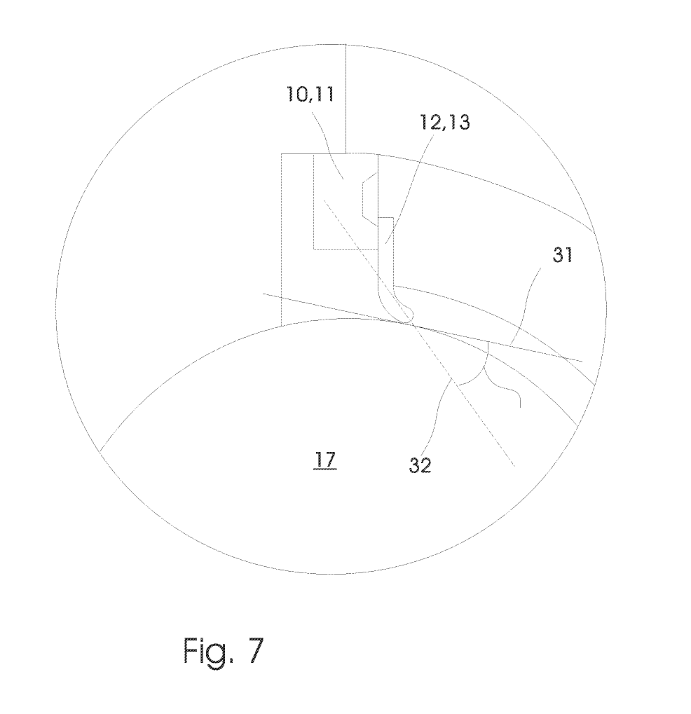

FIG. 7 shows, the tangent of an anilox roller in the contact point with a doctor blade and an interpolated line created through the bended part of a doctor blade.

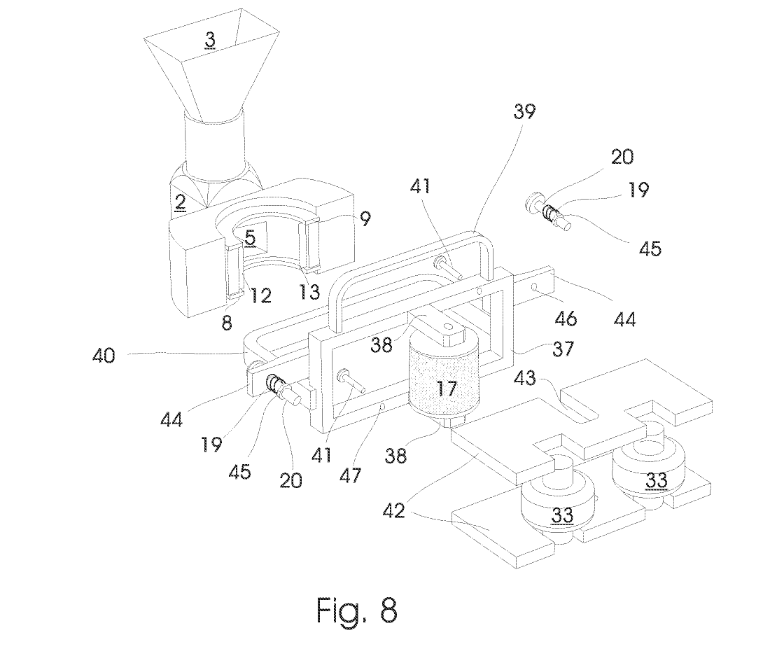

FIG. 8 shows in a perspective partly exploded view the two parts of an integrated unit and a third part for docking the integrated unit

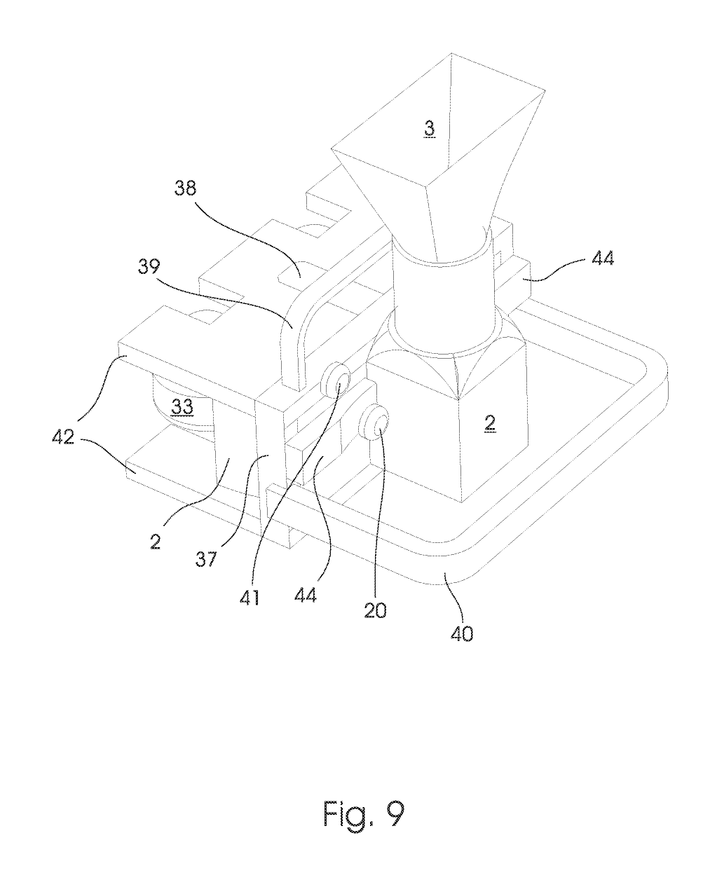

FIG. 9 shows in a perspective view the integrated unit of FIG. 8 assembled and docked in a docking part.

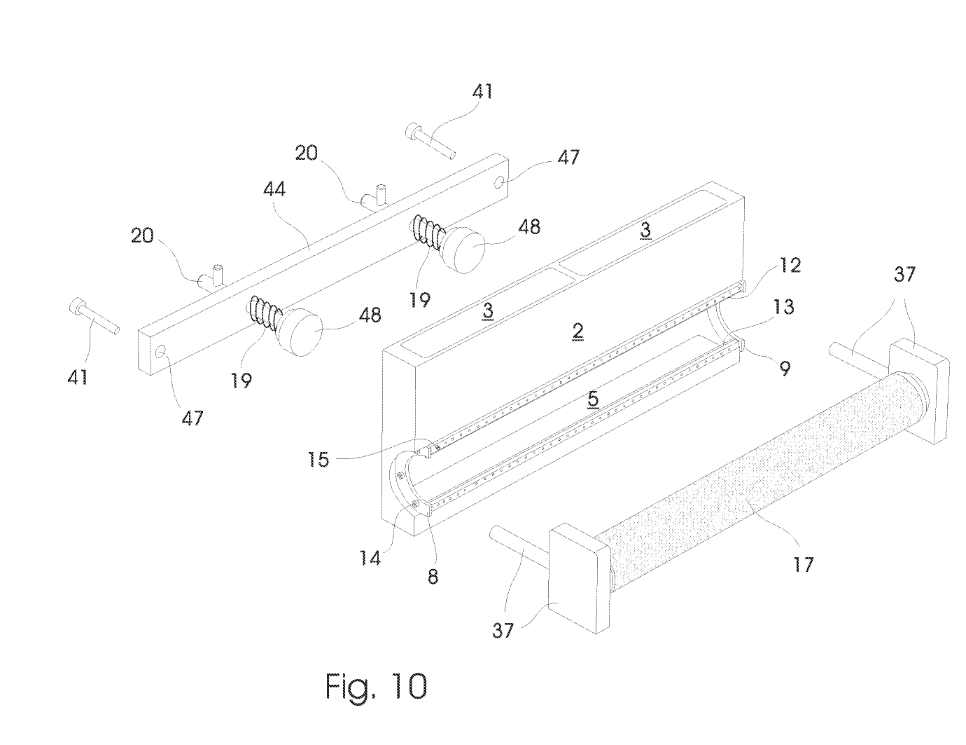

FIG. 10 shows, in a partly exploded view, an embodiment of the doctor blade chamber in which the longitudinal axis of the anilox roller is horizontally oriented

The invention is described below by way of example with the assumption that the doctor blade chamber is used in communication with a dry offset printing system. However, within the scope of the invention the doctor blade chamber can be used with other printing systems.

In FIGS. 1 and 2 a doctor blade chamber 1 for high viscous ink is shown. The doctor blade chamber 1 comprises a hollow casing 2 having a casing opening 3 which functions as both ink inlet and air outlet. The hollow casing has a curved inner surface 4 with a chamber opening 5.

Using clamps 10,11 the doctor blades 12,13 are mounted onto surfaces 22,23 by means of clamp bolts 15.

The hollow casing 2 is in this embodiment of the invention the main body for the doctor blade chamber 1. Partitioning walls 8, 9 are mounted by means of wall bolts 14 to a recess area of a first casing surface 6 and a second casing surface 7 of the hollow casing. The partitioning walls 8,9 function both as partitioning walls delimiting the ink chamber 16 and also as sealings against the anilox roller 17 (only shown in FIG. 2).

Assembling said hollow casing 2, with partitioning walls 8,9 and doctor blades 12, 13 and using the anilox roller 17 as a delimiting wall, an ink chamber 16 with a general shape of a semi-circular tubular volume with a rectangular cross section is created.

The partitioning walls 8, 9 delimit the tubular volume in two opposite directions and the curved inner casing surface 4 opposite of the anilox roller 17 delimit the tubular volume in other two directions perpendicular to the directions of the partitioning walls 8,9. The doctor blades 12,13 define the ends of the tubular volume and thereby the ends of the ink chamber 16.

When ink 21 is filled into the casing opening 3 that function as an inlet opening, the ink is lead through the chamber opening 5 into the ink chamber 16. When the doctor blade chamber 1 is fully filled with ink 21 the ink will be contained both in the ink chamber 16, the chamber opening 5 and in the hollow casing 2.

In the ink chamber 16 the ink 21 is transferred to the anilox roller 17 without applying pressure to the ink chamber. Therefore, it is possible to leave the ink chamber 16 open, whereby air from the empty cavities of the anilox roller is let out through the casing opening 3.

When starting the rotation of the anilox roller 17, a small force might be added to the ink, ensuring that the ink 21 is in contact with the anilox roller 17. After the start up the ink 21 will be drawn towards the anilox roller 17 with no means of pressure or force applied.

When the present embodiment of the invention is filled with ink 21, the ink 21 will be contained partly in the ink chamber 16 partly in the chamber opening 5 and in the hollow casing 2.

The chamber opening 5 has a rectangular form that easily allows the ink to be transported from the hollow casing 2 into the ink chamber 16. However, this shape could within the scope of protecting be of any geometrical form.

A relatively large bore of the casing opening 3 is preferred in order easily to feed the doctor blade chamber 1 with pasty ink or other high viscous ink.

In the process of filling a cavity 18 of the anilox roller 17 with ink 21 from the ink chamber 16 the air contained by the empty cavities 18 is displaced from the cavities into the ink chamber 16. Having an open ink chamber 16 said air leaves the ink chamber 16 through the chamber opening 5 and is let out through the casing opening 3, thereby avoiding that air gets trapped in the ink chamber. Trapped air in the ink chamber could block the ink 21 from getting in contact with the anilox roller. This would eventually leave cavities empty and cause areas in the final print left without ink.

The doctor blades 12,13 are firmly connected to the hollow casing 2 by clamps 10,11 and bolts 15. The rounded outline of the doctor blades 12,13 are resting under a spring load against the anilox roller 17. This spring load is achieved by the external springs 19 held by the spring bolts 20. The spring bolts 20 are in communication with the printing system (not shown) via the anilox roller frame 37 holding the anilox roller 17 (holding means not shown). Thereby, the spring bolts 20 force the springs 19 to pressing the doctor blades 12, 13 against the anilox roller. The springs apply a spring power sufficient to deflect the doctor blades 12,13 and further sufficient to allow the inner outline of the partitioning walls 8,9 to be in ink-tight contact with the anilox roller 17. The inner outlines of the partitioning walls have a smooth contact area. This way the inner outlines of the partitioning walls 8,9 get in so close contact with the anilox roller that no sealings are needed in order to keep the ink 21 in the ink chamber 16.

FIG. 3 shows a cross sectional view of a doctor blade chamber 1 and an anilox roller 17. Enlarged sectional views 3a and 3b shows a doctor blade 12,13 in contact with the anilox roller 17.

The friction between the doctor blades 12,13 and the anilox roller 17 generates heat that causes the temperature in the ink chamber 16 to rise. Such rise in temperature is normally avoided because the viscosity of the ink for most ink decreases in relation to rising temperature. This is normally an undesired feature because the printing system then continuously needs to be adjusted in relation to the change in the viscosity.

However, the build up of the doctor blade chamber of the present invention and thereby the possibility of using high viscous ink has generally made it indifferent to changes in viscosity of the ink.

Enlarged sectional view FIG. 3a shows, that during rotation of the anilox roller 17 the ink 21 in the ink chamber 16 is brought in motion. A layer of ink closest to the anilox roller is brought in motion and pushed forward along the perimeter of the anilox roller in the rotational direction of the anilox roller. When this layer is brought in contact with the doctor blade 13, the rounded outline of the doctor blade presses the ink partly in the cavities of the anilox roller and partly above the doctor blade towards the curved inner surface 4 of the casing. The rotation of the anilox roller constantly forces more ink towards the doctor blade than the cavities of the cavities of the anilox roller remove from the ink chamber. Therefore, the ink is forced to follow the inner surface of the casing and in the opposite direction of the rotation of the anilox roller.

This results in a region within the body of the ink near the doctor blade, in which ink has an angular velocity. Said region of locally rotating ink is continuously in communication with the rest of the ink 21.

In FIG. 3b it is seen that a string of ink 26 is formed outside the ink chamber 16. This string lubricates between the doctor blade 12 and the anilox roller 17 and therefore both are subjected to less tear and wear. The string is self-aligning and therefore a build up of ink is not likely to occur. If ink starts to build up, the pressure from the string will open up a larger passage between the anilox roller and the doctor blade 12, thereby allowing more ink back into the ink chamber. FIG. 3c shows an enlarged cross sectional view of the anilox roller 17. Cavities 18 filled with ink 21 are seen.

FIG. 4 and FIG. 4a shows a front view of the hollow casing 2 in a slightly tilted position. The front surfaces 22,23 is seen whereto the doctor blades are mounted by means of the clamps 10,11. Furthermore, two recesses 24,25 are shown. Onto these recesses 24,25 in the surfaces 6,7 the partitioning walls 8,9 are mounted.

In FIG. 5 a schematic cross sectional view of a dry offset printing system 28 using a doctor blade chamber 1 is shown.

It is seen that the doctor blade chamber 1 is in communication with the anilox roller 17. The ink 21 is transferred to the form rollers 33 who distribute the ink to the cliché roller 34. The cliché is a mirror image of the final print. The cliché transfers said mirror image to the rubber blanket roller 35, which finally transfers the print to the desired print material.

The doctor blade chamber has proven to be equally suited for printing systems having a horizontal as well as a vertical orientation of axis of the rollers.

FIG. 6 and FIG. 6a shows embodiments of convex doctor blade outlines. FIG. 6 shows a doctor blade with a semi circular outline 29 and FIG. 6a shows a doctor blade with a semi ellipsoid outline 30.

In FIG. 7 an enlarged sectional view of an anilox roller 17 and a doctor blade 13 is shown. Due to the force applied on the doctor blade a part of the doctor blades are slightly bend when ready for use. In the contact point of doctor blade and the anilox roller a tangent 31 to the anilox roller can be drawn. The intersection between said tangent and an interpolated line of the bended part of the doctor blade 32 generates an acute angle outside the ink chamber 16 of 25° to 75°.

FIGS. 8 and 9 shows an embodiment of the present invention in which the doctor blade chamber 1 and the anilox roller frame 37 can be assembled into one integrated unit. The anilox roller 17 is mounted in an anilox roller frame 37 that is not at part of the printing machine (not shown). The anilox roller frame 37 has two docking arms 38 between which the anilox roller 17 is placed. Furthermore, attached to the anilox roller frame 37 a first handle and a second handle 40 are attached. Similar to the embodiment described in FIGS. 1 and 2 the doctor blade chamber 1 is mounted on the anilox roller frame 37 by means of casing bolts 20 around which springs 19 apply a spring force on the hollow casing 2. The casing bolts 20 are positioned through the holes 46 in the clamping bars 44 and a recess or a nut 45 hold the spring 19. In FIG. 8 the two clamping bars 44 are shown in an outward position whereby the doctor blade chamber 1 can be inserted in such way that the anilox roller frame 37 surrounds the hollow casing 2.

In order to ensure a precise positioning of the integrated unit the docking arms 38 are adapted to fit into a docking slot 43 in the form roller docking plates 42. The docking slot 43 ensures that the correct positioning between the anilox roller 17 and the former roller 33 is obtained. Furthermore, the rotation of the anilox roller 17 and the forme rollers 33 are obtained from gearwheels (not shown), The frame bolts 41 placed through the frame holes 47 into threaded holes (not shown) in the forme roller docking plates 42 combines the integrated unit onto the forme roller docking plates 42.

Finally, the forme roller docking plates 42 are mounted on the printing machine (not shown) to get the former rollers 33 in contact with the successive rollers of the printing machine.

In a further extend version of the integrated unit, the forme roller docking plates 42 could be a part of the integrated unit, whereby the integrated unit further would comprise the lifting mechanism e.g. a camshaft (not shown) for the forme rollers 33.

FIG. 9 shows the integrated unit assembled and the docking arms 38 placed in the docking slots 43 in the forme roller docking plates 42.

It is shown that the hollow casing 2 is inserted in the anilox roller frame 37 and the clamping bars 44 are turned 180° so that the casing bolts 20 are positioned to get in contact with hollow casing. This way the bolts 20 by means of the springs 19 (not visible in FIG. 9) applies a force towards the hollow casing 2 forcing the doctor blades 12,13 and the sealings 8,9 against the anilox roller 17 constituting a tight fitting.

FIG. 10 shows an embodiment of the present invention of which the anilox roller 17 has its longitudinal axis in a horizontal plane. This embodiment is typically used for anilox rollers up to 1500 mm in length. As for the previous build-up having a vertical longitudinal axis of the anilox roller a force applied by the springs 19 to the hollow casing 2 results in that the doctor blades 12,13 and the sealings 8,9 is brought in tight contact with the anilox roller 17. Held by frame bolts 41 through frame holes 47 a clamping bar 44, in the main in the length of the anilox roller 17, facilitates an optimal positioning of the springs 19 and the casing bolts 20.

By screwing the frame bolts 41 into threaded holes (not shown) in the anilox roller frame 37 the anilox roller 17 drawn in contact with the doctor blades 12,13 and thereby in communication with the hollow casing 2. The frame bolts 41 are tightened until the doctor blades 12,13 are in contact with the anilox roller 17 and thereafter a tight fitting is achieved adjusting the clamping bolts 20 so that the springs 19 applies a force onto the hollow casing 2. In order to distribute the spring power from the springs 19 the clamping bolts 20 are fitted with end caps 48 giving an enlarged contact area to the hollow casing.

The casing opening 3 extends in the main in the full length of the hollow casing 2. Such large opening is a tremendous help in filling the doctor blade chamber 1 with ink.

1.-18. (canceled)

19. A doctor blade chamber for transferring viscous ink having a viscosity of at least 20 Pa·s to at least one anilox roller, comprising
at least two doctor blades,
at least one partitioning wall, and
at least one casing opening in a hollow casing having a curved inner surface with a chamber opening which together with the anilox roller defines an ink chamber, the ink chamber comprising an inlet opening and an outlet for air,
wherein the doctor blade chamber is arranged to be in free communication with the surroundings and the doctor blades rest under a spring load against the anilox roller.

20. The doctor blade chamber according to claim 19, wherein the casing opening acts as both ink inlet and air outlet.

21. The doctor blade chamber according to claim 19, wherein the doctor blade chamber is mounted with the axis of rotation of the anilox rollers horizontally or vertically aligned.

22. The doctor blade chamber according to claim 19, wherein the doctor blade chamber is substantially symmetric.

23. The doctor blade chamber according to claim 19, wherein the partitioning walls have an inner outline in ink-tight contact with the anilox roller.

24. The doctor blade chamber according to claim 19, wherein the anilox roller and the doctor blade chamber constitute an integrated unit detachable from the printing machine.

25. The doctor blade chamber according to claim 19, wherein a tangent of the anilox roller and an interpolated line of the doctor blade intersect to define an acute angle of between 25° and 75°.

26. The doctor blade chamber according to claim 19, wherein the doctor blades are made of a metal or a plastic composite.

27. The doctor blade chamber according to claim 19, wherein the doctor blade chamber is in communication with a cliché.

28. A process for transferring viscous ink having a viscosity of at least 20 Pa·s to at least one anilox roller using the doctor blade chamber according to claims 19, which comprises:
filling a printing ink having a viscosity of not less than 20 Pa·s and at least 80% pigment to the doctor blade chamber through the inlet opening, and
transferring the printing ink to the anilox roller while simultaneous rotating the anilox roller, with the at least two doctor blades scraping excessive ink off the anilox roller and leading air from the anilox roller.

29. The process according to claim 28, wherein the anilox roller is rotated at a speed of at least 20 rpm.

30. The process according to claim 28, wherein the process is a dry offset printing process.

31. A print obtainable by the process according to claim 30.

32. Paper, cardboard, plastic materials or egg trays comprising prints according to claim 31.
